(19) United States
(12) Patent Application Publication
(10) Pub. No.: US 2024/0371287 A1
(43) Pub. Date: Nov. 7, 2024

(54) MOBILE TEACHING DEVICE, SYSTEM, AND METHOD

(71) Applicant: Teach by Tech, Arvada, CO (US)

(72) Inventors: Linnie Pawlek, Arvada, CO (US); Andrew Pawlek, Arvada, CO (US)

(21) Appl. No.: 18/656,583

(22) Filed: May 6, 2024

Related U.S. Application Data
(60) Provisional application No. 63/464,167, filed on May 4, 2023.

(51) Int. Cl. G09B 5/06

(52) U.S. Cl. CPC G09B 5/06

(57) ABSTRACT

Systems and methods are described for a mobile teaching system or device for delivering digital content to students without ready access to the internet and/or materials for learning. In some aspects, a mobile teaching system may include a computing device, a display device, such as a projector, and a memory device for storing an offline digital library of content. The mobile teaching system, in some cases may be at least in part contained within a sealable housing or case, to provide for safe transport a robust operation of the mobile teaching system in various situations. In some examples, the mobile teaching system may include one or more power sources, such as rechargeable power sources, solar power sources, or a combination thereof to provide for robust operation when other power sources are not available.

### CROSS-REFERENCE TO RELATED APPLICATIONS

This application claims the benefit of U.S. Provisional Patent Application No. 63/464,167, titled “MOBILE TEACHING DEVICE, SYSTEM, AND METHOD,” filed May 4, 2023, the disclosure of which is incorporated herein by reference in its entirety.

### BACKGROUND

Refugee and immigrant learners face enormous challenges, as their lives have often been upended and their own families' futures are uncertain. The 21st Century demands understanding and abilities within at least the following areas: learning skills, including critical thinking, creativity, innovation, collaboration and communication; literacy skill s, including reading, writing, numeracy, information, media and technology; and life skills, including leadership, productivity, advocacy and personal and social responsibility. All of these skills can be essential to knowledge creation. However, conflict and crisis, violence and human rights violations, among various other challenges for underrepresented groups do not offer a solid foundation for the acquisition of these skills.

While there is language and vocational training available to refugee, immigrant, and other marginalized communities, these opportunities often require participants to travel to a specific location, have access to internet/broadband, understand technology and/or adhere to a strict schedule of classes. In addition, many of these opportunities are not designed to readily overcome cultural and linguistic barriers. The road to success for refugee and immigrant learners (and their potential to make substantive contributions to their new host societies) depends upon their ability to make sense of their new and often volatile environments.

In view of the foregoing, a need exists for improved teaching systems and methods in an effort to address the aforementioned obstacles and deficiencies of existing and conventional techniques.

### BRIEF DESCRIPTION OF THE DRAWINGS

Various techniques will be described with reference to the drawings, in which:

FIG. 1 illustrates an example of a mobile teaching device or system at least partially contained within a sealable housing, according to at least one embodiment;

FIG. 2 illustrates an example of a mobile teaching device or system, according to at least one embodiment;

FIGS. 3A, 3B, and 3C illustrate example views of a mobile teaching device or system at least partially contained within a sealable housing, according to at least one embodiment

FIG. 4 illustrates an example of a mobile teaching device or system in communication with a mobile device, according to at least one embodiment;

FIG. 5 illustrates multiple views of an interface and connections for a mobile teaching device or system, according to at least one embodiment;

FIGS. 6 and 7A-7D illustrate example views of a heatsink device which may be implemented in the mobile teaching device or system of FIGS. 1-5, according to at least one embodiment;

FIGS. 8A-B illustrates an example of a mobile teaching device or system including a solar power collecting device, according to at least one embodiment;

FIGS. 9A-9B illustrates an example of a mobile teaching device or system including a projection device contained within a sealable housing, according to at least one embodiment;

FIG. 10 illustrates an example of a mobile teaching device or system including a projection device extending at least partially outside of a sealable housing, according to at least one embodiment; and

FIG. 11 illustrates an example schematic of a mobile teaching device or system including, according to at least one embodiment.

### DETAILED DESCRIPTION

Systems, devices, and techniques are described for a mobile teaching/learning system, such as may be used to increase and enhance access to digital content to various locations that may not have readily available power and/or network connectivity. In some examples, a mobile computing device (herein referred to also as a mobile teaching or learning device), may be loaded with digital content, such as may form a library of educational material (e.g., digital books, audio files such as audio books, instructional material, podcasts, etc., instructional videos, etc.). In some cases, the mobile teaching device may include a (e.g., large) removable memory, such as an SD card, to enable the rapid delivery of new materials (e.g., digital content) in a small memory device that is easy to ship, such as to remote places. In some cases, the mobile teaching device may provide a user interface to access the materials on the device itself. In yet some cases, the mobile teaching device may additionally or alternatively include wireless capabilities (e.g., a Wi-Fi or Bluetooth connection, or technology that emulates such a connection) and/or various ports for wired connections to one or more external display and/or audio devices (e.g., projectors, speakers, other mobile computing devices such as smart phones, tablets, laptops, etc.), that can be used to display, play, or otherwise present the digital content of the library to users (e.g., teachers and students). In various cases, the mobile teaching device may have one or more power sources, such as batteries, rechargeable batteries, solar panels to recharge and/or power the device, wired connections to external power, or various combinations thereof, to provide for flexibility as to where the device can be used.

In some cases, the mobile teaching device may be a limited purpose device, such as to reduce costs of making the device, limit power consumption of the device, and/or to limit access to other resources by students (e.g., restricted or having no access to outside internet, for example). In this way, a more robust and purpose built device may be implemented, and may be shared by multiple users (e.g., a single classroom with one or possible multiple display devices).

In some aspects, the mobile teaching device may be part of a mobile teaching system, such as may be contained within a case. The mobile teaching system may contain one or more of the mobile teaching device, a projector, and a power source, for example, as well as cables and connectivity to other devices. In this example, a single complete mobile teaching system may be made to be readily portable and durable, such as to obviate or drastically reduce the need for onsite repairs, and increase access to learning material to underserved and/or remote communities. A more detailed example of a mobile teaching device and system will be described in greater detail below.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) improved access to learning materials for students with limited or no internet connectivity; (2) a reduction in network bandwidth usage to deliver various content to remote locations for teaching; and (3) other advantages as will be made apparent in the rest of this disclosure.

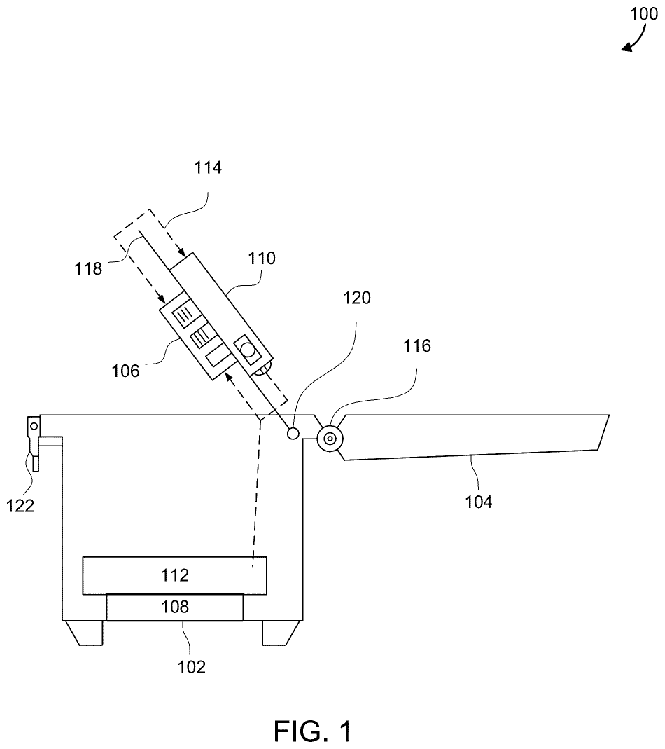

FIG. 1 illustrates an example of a mobile teaching device or system 100. In some cases, the mobile teaching device 100 may be all or partially enclosed in a housing or container 102 with an attached or removable lid or closure 104. In some cases, container 102 and lid 104 may include or form a portable waterproof case that has been modified to contain one or more of: a computing device 106 (e.g., a raspberry pi microcontroller), a custom built heatsink 108 to obviate the need for a fan (e.g., reduced power consumption in situations where power is scarce), a projector or projection device 110 as well as a power source 112 and/or power cord (not shown), and any device connection cords 114 (e.g., the device connection cord, such as USB or USBC, an HDMI cord or other cord to connect the computing device 106 to the projector 110, etc.).

In some cases, the container or housing 102 may be coupled to a lid or enclosure portion 104 via one or more hinges 116. In various cases, the housing 102 and/or lid 104 may be constructed of various composite materials (poly-based materials, plastics, etc.), metal, or one or more various other materials. In some cases, the lid 104 may be removably attached to the housing 102, such as by hinge 116. In yet some cases, the lid 104 may be secured to the housing 102 via a latch mechanism 122, such as to form a watertight or airtight enclosure defining a space for which one or more of the computing device 106, projector 110, power source 112, heatsink, and/or other components may be safely and securely stored and/or attached to the housing 102 and/or lid 104.

In some cases, the projector 110 and/or the computing device 106 may be mounted or attached to opposite sides of a plate or surface 118 (e.g., made out of any of a variety of composite materials, metal, etc.), which may be attached to the housing 102 via a second hinge 120, to enable access to a space within the housing below the plate 118. In some examples the plate may include a hinged internal mounting panel, such as part number ZX-0606K-02. In this way, the housing 102 and lid 104 may form both a secure mobile teaching system or device 100 and a storage compartment for various items. In some cases, mobile teaching system 100 may be securely shipped as a complete unit, to better facilitate providing access to teaching materials to remove locations. In some examples, the housing may include a hinged junction box, such as part number ZH-060604.

In some aspects, the described systems and methods include an offline digital library, which may be stored by and accessed via a mobile computing or learning device (herein referred to as a mobile teaching device or system). In some cases, the offline digital library may include various data for teaching, such as may include text, pictures, videos, audio recording, prepared presentations, etc., in one or more different languages. In various cases, different digital libraries may be stored on various removable storage device (e.g., SD cards, memory cards such as USB memory cards, and various other devices used to store small to large amounts of data. In various cases, the mobile teaching device 100 may include one or more ports or connectors for connecting removable storage devices to the mobile teaching device, to then be presented via projector 110, such as to various students. In some aspects, one or more network interface devices may also be in communication with the computing device 102 to enable various network enabled devices to connect to the mobile teaching device, such as to download one or more digital libraries to storage connected to the mobile teaching device 100. By enabling at least these types of access to digital content, the mobile teaching system may be made more robust and facilitate data transfer in a large number of scenarios.

The mobile teaching device may be loaded with a digital library, to provide for access to materials of the digital library when network connectivity is not available or not possible, or not conducive to learning. One purpose of the mobile teaching device is to enable smartphone and computer users the ability to view or download digital content to their device for viewing later.

The described system and techniques may be realized by using various technologies to make a mobile system that has computing or processing capabilities, video projector capabilities or other display means, supplied by one or more power supplies. In some cases, the computing system may include a specific purpose device, such as a raspberry pi 4 microcomputer or various other similar devices, including various other micro-computers, microprocessors, or various other computing devices, that provide the functionality described in greater detail below. In some cases, the display means may include a consumer video projector, such as, for example, a Kodak RODP with multiple USB ports and 75 lumens, which may connect to the computing device via wired or wireless connections, such as a USB or other data transfer type cable, various wireless communications technologies such as Wi-Fi, Bluetooth, and the like. In other cases, the display means may be provided by a separate computing device with a screen, such as a smart phone, tablet, laptop, or desktop computer, for example. In some cases, the one or more power sources may include one or more of a solar power bank, batteries, such as rechargeable batteries, or a power adapter to enable the device to be supplied with power from an external power source (e.g., a wall plug).

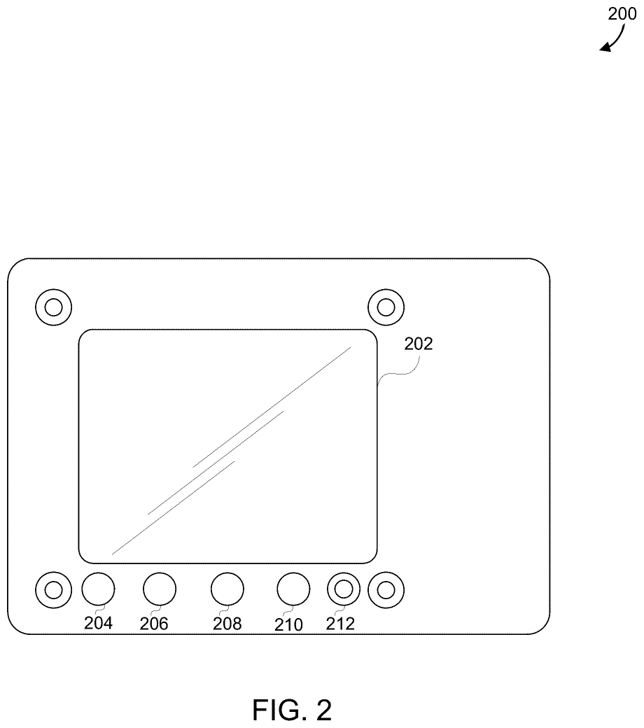

In some cases, the mobile teaching device or system may include a user interface, an example of which illustrated in FIG. 2. User interface 200 may include various controls and interfaces (physical and/or implemented in software) for accessing, configuring, and presenting data to an audience, such as students, through a mobile teaching device or system. In the example illustrated, user interface 100 may include a screen 202, and various physical controls of buttons 204, 206, 208, 210, and 212 for performing various actions with respect to a mobile teaching device. In some aspects, buttons may include push buttons, dials or knobs that turn, and various other physical buttons or mechanism for interacting with the mobile teaching device. In some cases, one or more of screen 202, and/or controls 204-212 may include one or more touch sensors to enable touch input to control the mobile computing device. It should be appreciated that various other control interfaces may be similar implemented in conjunction with a mobile teaching device or system, as described herein.

In some aspects, user interface 200 may include an LCD (High PPI) display associated with or connected to the mobile learning device, such as a device built by a company named Geekworm. In this example, the screen is 2.4 inches and has a resolution of 320×240, whereby software, such as pygame, may control the screen. When the device starts, users are unable to access the drive in any way outside of the prescribed use. In some cases, the display turns on when the device starts through the custom software that uses pygame. In some cases, the display may show a QR Code (quick response barcode), or other type of unique identifier, which end users can scan to be delivered to the library interface, as a primary or fallback for users that could not reach the library via the captive portal redirects.

In some aspect, the mobile teaching device may include a display, commonly referred to as a HAT for the raspberry pi that is a touch screen, and in some cases may also have any number of buttons or selectable items built in. As described above in reference to FIG. 2, five buttons are illustrated, including four brass buttons and one plastic button, that with proper programming allows changing the items displayed on the display.

In some aspects, each of the buttons may be individually programmable. For example, one button may be programmed to turn the display off, such as to conserve power, another button programmed to turn the display on, one button to display a splash screen with a web-address that links to the library and a fourth button to change the display to show the QR code. In some aspects, the fifth button may not be utilized, such as to allow customization by the user or programmer, as need or specific circumstances arise.

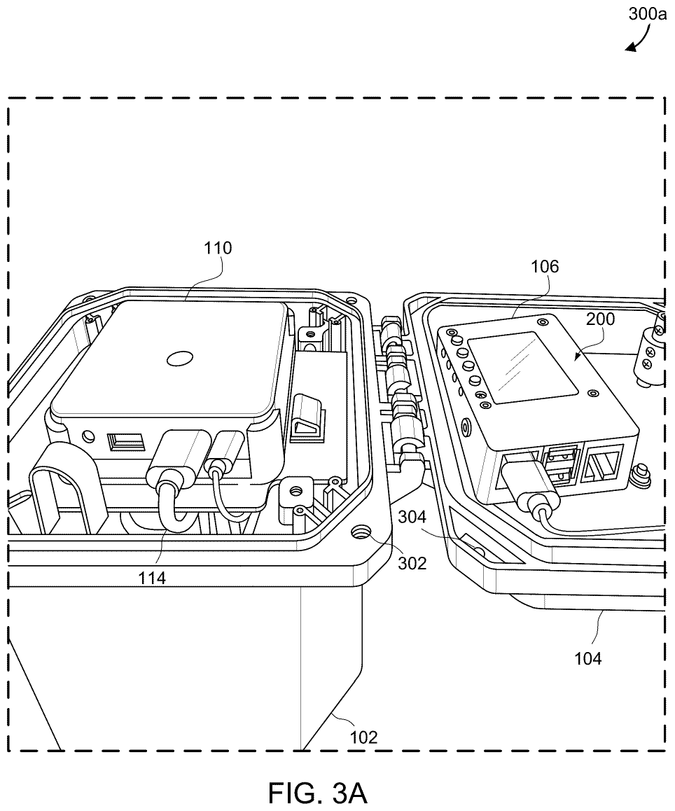

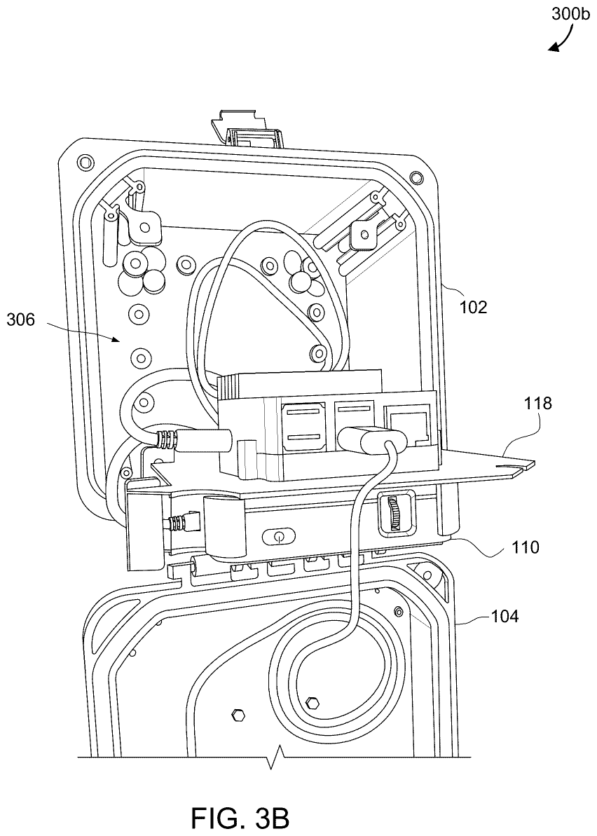

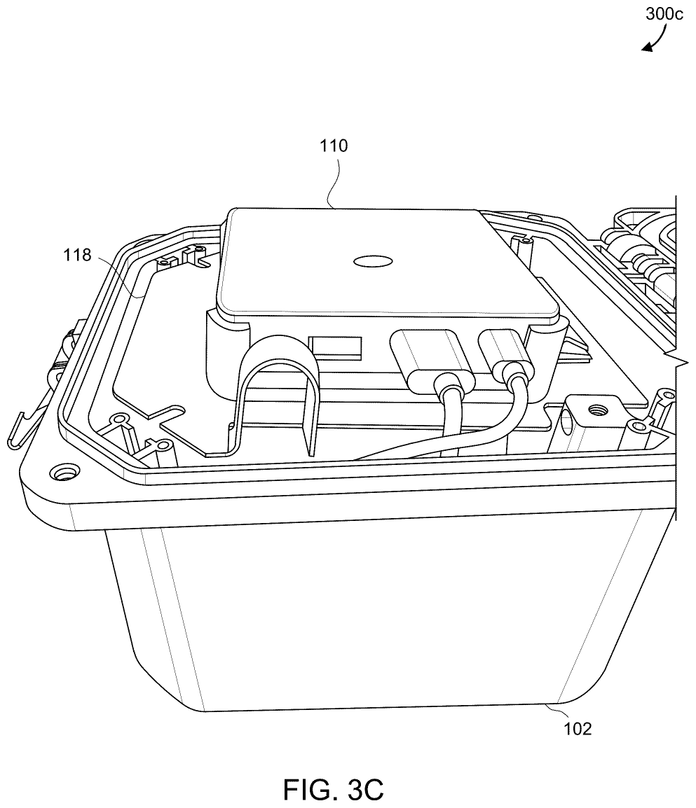

In some cases, the mobile computing/learning device may employ various software that enable storage of digital content, updating and removal of digital content, connectivity wirelessly (or wired) to access the content. Example views of a mobile teaching system, including a mobile teaching device connected to a projector via a wired connection, enclosed in a case, is illustrated in FIGS. 3A, 3B, and 3C. In some cases, vies 300a, 300b, and 300c may be more detailed examples of the mobile teaching device 100 described above in reference to FIG. 1. Components illustrated in views 300a, 300b, and 300c of the mobile teaching device may be examples of and/or include one or more aspects of similar number components described above in reference to FIG. 1.

As illustrated in FIG. 3A in view 300a, lower housing 102 may include one or more threaded portions or other mechanism 302 for receiving a fastening device (not shown), such as a screw or other removable fastener, for secure lid portion 104 to the lower housing to form a seal around one or more of the components located within housing 102. In some examples the lower housing 102 may form a rectangular cross section, such that one or more fasteners/threaded portions may be disposed at approximately each corner of the housing 102, and unthreaded holes or openings 304 corresponding to these locations may be formed on the lid portion 104. A removable fastener may then be inserted through hole portion 304 and tightened into threaded portions 302 to form an airtight or watertight seal around the space formed inside of the housing 102 and lid 104. In various other examples, the housing 102 and lid 104 may form any of a variety of different shaped cross-section (triangular, circular, oval, square, etc.) whereby any number of fasteners and corresponding threaded and hole portions may be formed on the housing and lid portions. In various cases, the airtight seal may be formed for moving the mobile teaching device and/or in some cases, such as where the projector is displayed within the housing and lid, the device may operate when the housing and lid and sealed.

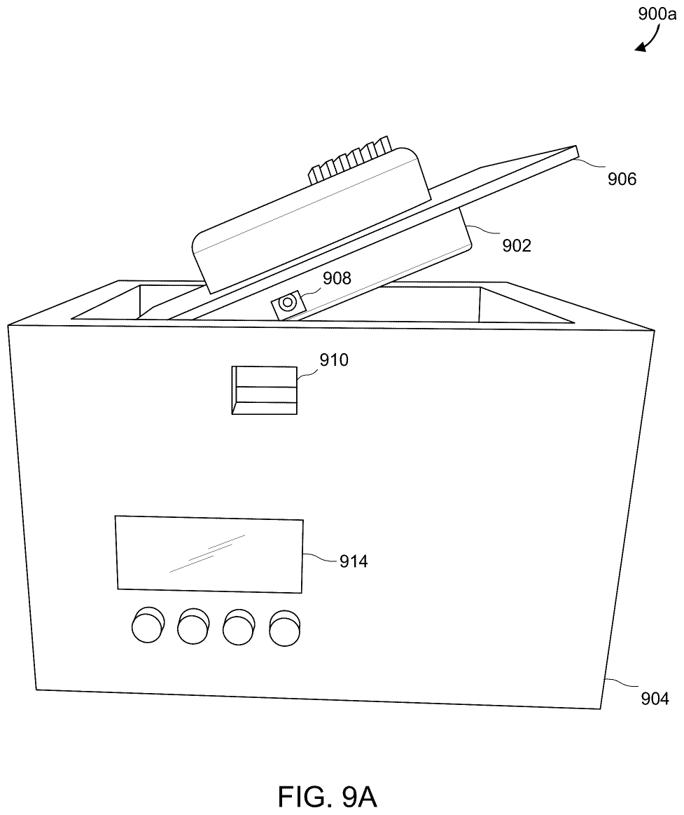

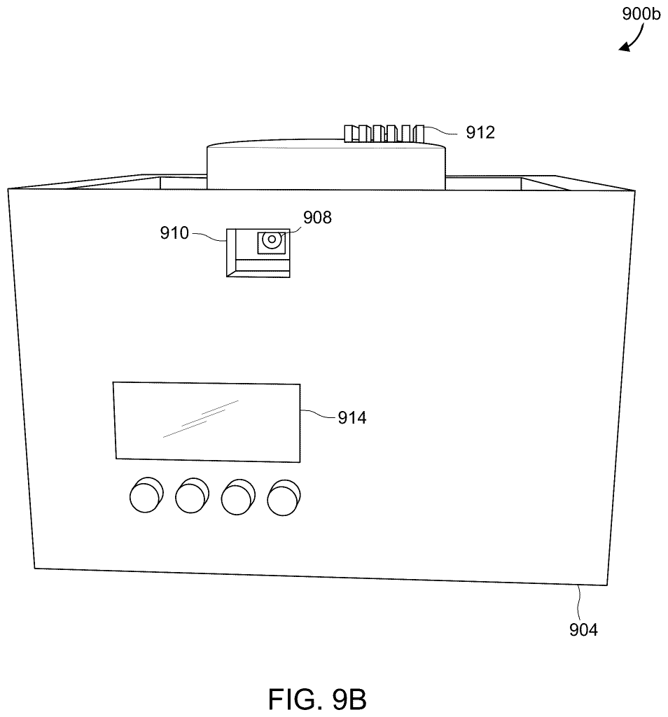

As also illustrated in FIG. 3A, a user interface 200, such as described above in reference to FIG. 2, may be movably disposed within the housing 102 and/or lid 104, such as may form part of the computing device (e.g., in the example of a raspberry pi computing system). In other cases, such as in the examples 900a, 900b, and/or 1000, as described below in reference to FIGS. 9A, 9B, or 10, the user interface may be disposed on an outside surface of housing 102/lid 104, such as to enable operation of the device when the housing and lid are attached/scaled together.

View 300b of FIG. 3B illustrates the mobile teaching device with the projector 110 and the computing device 106 disposed on a plate 118 in an intermediate position between the housing 102 and the lid 104. As also illustrated in FIG. 3B, a cavity 306 may be formed within the housing 102 and the plate 118, such as to store additional cables (e.g., for connecting to different sources of digital content, such as via one or more network devices, or computing devices) and/or other accessories for operating the mobile teaching system.

View 300c of FIG. 3C illustrates the plate 118 in the closed position with projector 110 positioned approximately horizontal, such as to enable projection of data to one or more walls, screens, etc., for providing teaching materials to various students.

In some cases, the mobile teaching device may act as a wi-fi hotspot, though it is not connected to any network or internet. The mobile teaching device may utilize software to act like a bridged access point using various technologies, such as hostapd, which facilitates a phone home feature to send usage data back to a fixed server via a wired ethernet connection.

In some aspects, the mobile teaching device may employ a raspberry pi 4 microcomputer (or various other types of limited or specific purpose computing systems or devices) to control its functions. In some implementations, the mobile teaching device may use a 32 GB micro SD card to store the operating system as well as digital content. In some examples, the operating system may be a specific or limited operating system, such as raspian, which is a fork of the Debian Linux operating system. It should be appreciated that various other operating systems may be used to a similar affect. In the examples that use raspian, other software may also be used and modified to achieve the devices goals and facilitate the mobile learning system. Firstly, an open-source e-book software system may be employed, such as Calibre. This may be used as the database and taxonomy system for organizing the digital content, particularly e-books but also video and audio files, and/or various other types of files based on specific need or application. For example, e-books may primarily be of the filetype .epub. Next, in some cases, there may be an interface layer that is used to import files and to view files. In one example, this interface layer may include an open-source project named CalibreWeb. This interface layer allows an end user to use a web browser on a phone or mobile computing device, computer, laptop, tablet, or other computing device to view contents of the library, which may not be a feature of the base of the Calibre.

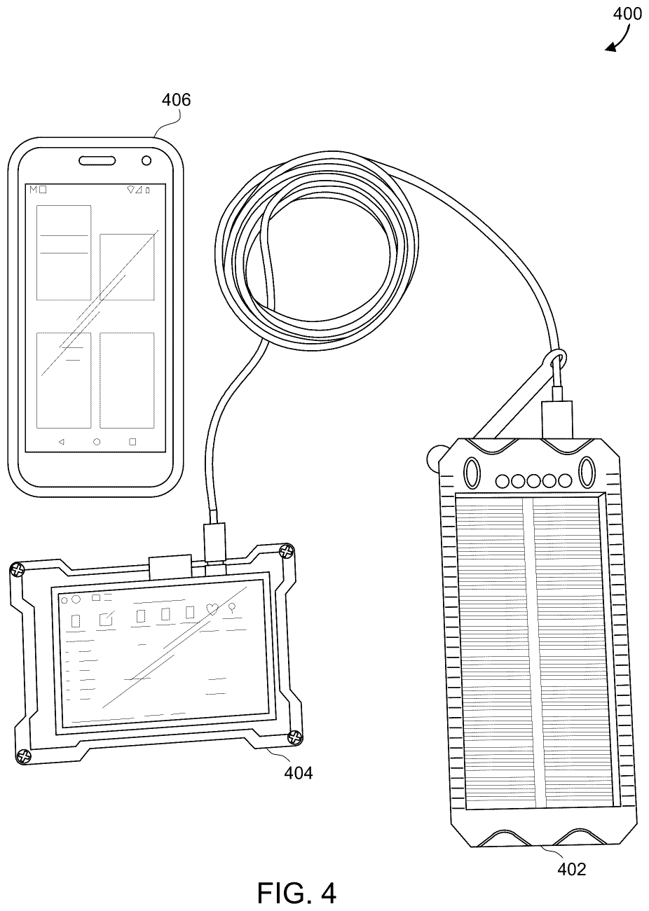

FIG. 4 illustrates an example 400 of a mobile teaching system including a computing device 402 connected to a user interface device 404, where one or more of the computing device 402 and/or the user interface device may communicate with an external mobile computing device 406 (e.g., illustrated as a smart phone) to access digital content stored on the external computing device 406. In some cases, writing to the mobile computing device 406 and/or computing device 402 may be password protected for administrators' use of the device, but public non-authenticated users can access the library, such as without the ability to add, delete, or edit the library or its contents. In various examples, the mobile computing system, including computing device 402 and user interface 404, may communicate with any of a variety of external computing devices 406, such as one or more mobile computing devise or smart phones, laptops, tablets, desktop computers, etc., via one or more wired or wireless communication links, to enable additional digital content to be displayed and/or provided by the mobile teaching system.

In some aspects, using hostapd, the mobile device broadcasts itself so that users can see the device in the Wi-Fi settings of their phone or computer. In some cases, this offline network is named and may appear as the TBT Digital Library or other library so named for easy identification of the purpose of the mobile teaching device. Users can then see this network and connect their devices to that. In some aspects, a custom script then redirects the newly connected device to what is commonly referred to as a captive portal. In some cases, the mobile teaching device may use a slightly modified version of a software package called nodogsplash, or other similar software or instructions, that may provide a lightweight captive portal solution that is easily set up and highly configurable. In some cases, following the display of the captive portal, the device once again redirects the user, this time to view the library, such as via a CalibreWeb instance.

Above is the description of example software used to access the device and its content. It should be appreciated that various other configurations are contemplated herein, such as may utilize various other physical devices and/or software, that together, may form a mobile teaching/learning system, as described herein.

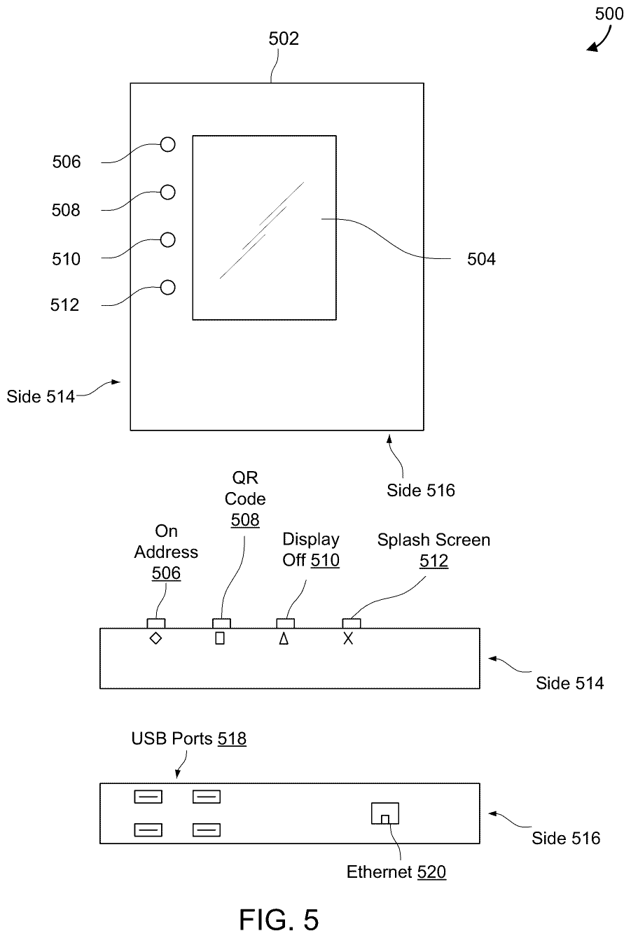

FIG. 5 illustrates different views/sides of a user interface device/computing device 500 and connectors, such as may be an example of the computing device and/or user interfaces described above. In one example, user interface device/computing device 500 may be an example of a microcomputing device, such as a raspberry pi device. Side 502 may include a user interface, such as including a screen 504, and any number of buttons or controls 506-512. Side 514 may show indicators for the various buttons or controls 506-512, including on address indicator/control 506, QR code indicator/control 508, display off indicator/control 510, and splash screen indicator./control 512. Side 516 may include one or more connectors or ports, such as one or more USB or similar ports 518 and/or one or more other ports 520, such as an ethernet port. It should be appreciated that the various controls and ports of FIG. 5 are only given by way of example, and that various other controls and connectors are contemplated herein.

In some cases, the mobile teaching device may be all or partially enclosed in a portable waterproof case that has been modified to contain one or more of: the computing device (e.g., the raspberry pi microcontroller), a custom built heatsink to obviate the need for a fan (e.g., reduced power consumption in situations where power is scarce), the projector as well as the power cord, and any device connection cords (e.g., the device connection cord (USBC) and the HDMI cord to connect the raspberry pi to the projector).

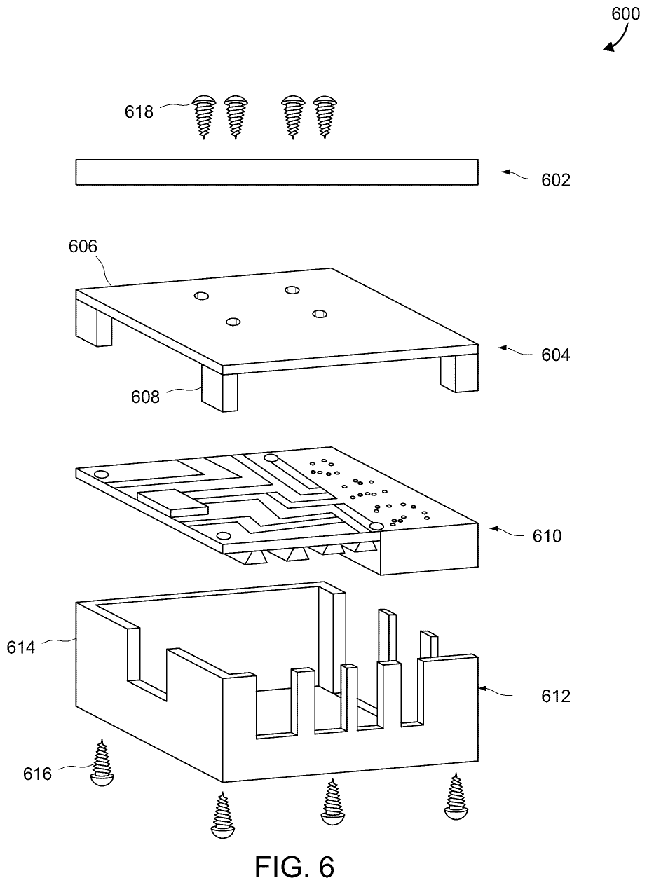

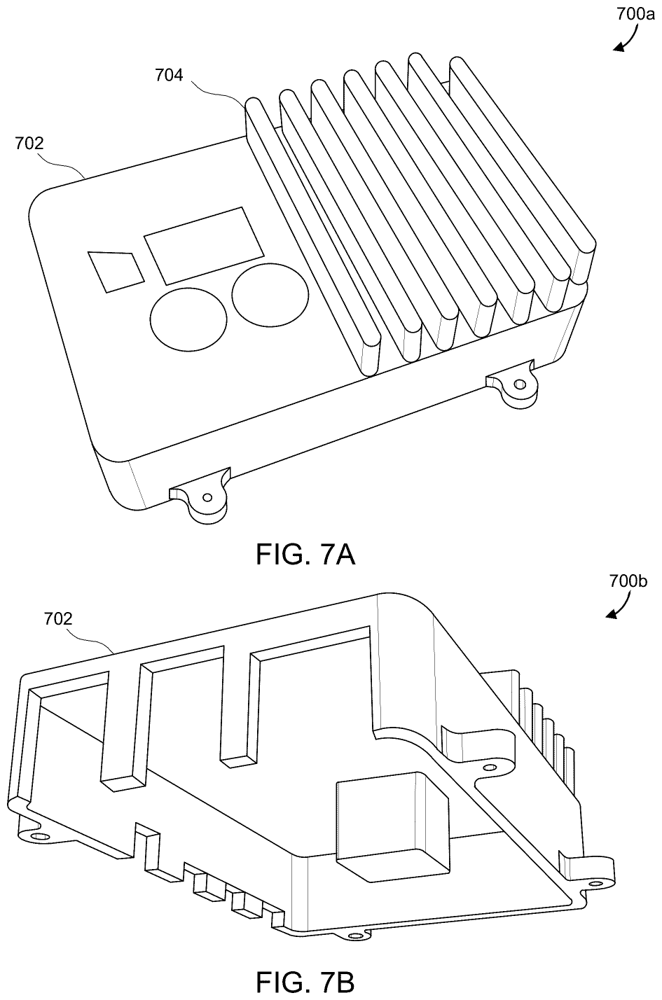

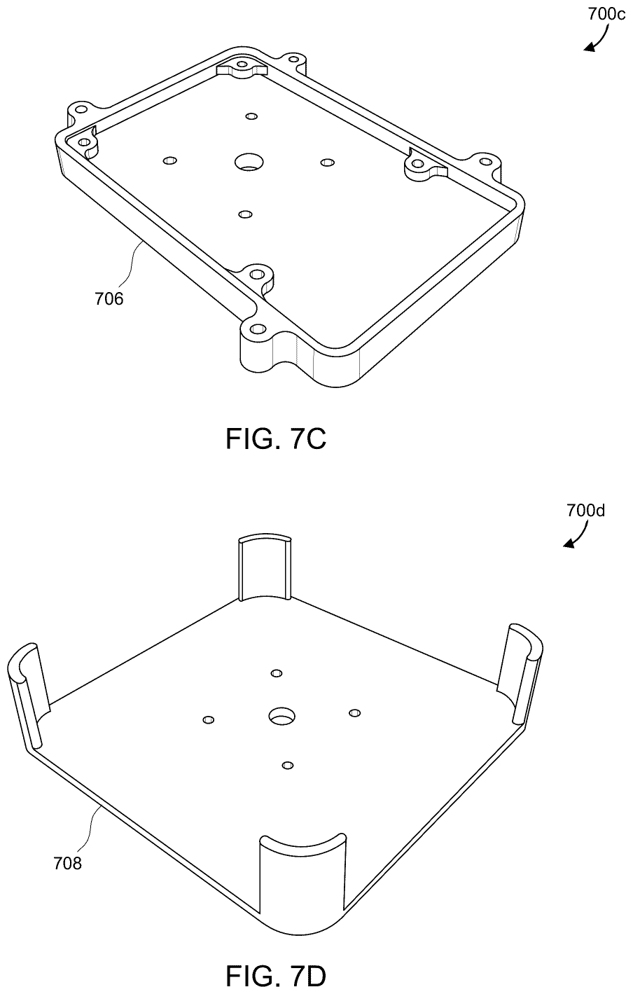

In some cases, a mobile teaching device or system may also include a heatsink, which may, in some cases, also act as an internal casing which attaches to a metal plate inside of the larger outer waterproof case, as illustrated in FIGS. 6 and 7A-7D.

As illustrated in FIG. 6, one example heatsink 600 may include a top plate 602 that attaches to a mounting plate 604. In some examples the top plate 602 may be a planar structure and form a rectangle, and the mounting plate 604 may include a planar structure 606 with four legs 608 extending downward from the corners of the mounting plate 604 which also forms a rectangle. In the example illustrated, the legs may form rectangular prisms, that may contact a computing device mounted on a board 610. A cover 612 may attach to the underside of the computing device, having walls 614 with opens to fit closely with the underside of the computing device 610. In some cases, the computing device 610 may be attached to the cover 612 via one or more fasteners 6161, which may include screws. Similarly, the top plate 602 may be attached to the mounting plate 604 via one or more fasteners 618, which may also be screws. In some cases, the heatsink 600 may be designed to increase airflow proximate to the computing device 610, such as via spaces or openings in walls 614 of the cover 612. In some aspects one or more of the plates/cover 602, 604, and 612 may made of metal (e.g., aluminum), plastic or other composite, and/or various other materials.

It should be appreciated that the size, shape, and/or number of different layers of the heatsink 600 are only given by way of example, and that various other designs and structures are contemplated herein.

FIGS. 7A-7D illustrate views 700a, 700b, 700c, and 700d of another example of different components of a heatsink. As illustrated views 700a and 700b are of a mounting plate 702, which may be an example of mounting plate 612 described above in reference to FIG. 6., having heat dissipating fins 704 on one side. In some cases, heat dissipating fins 704 and/or mounting plate 702 made be constructed of aluminum of other metal to promote dissipation of heat away from a computing device. View 700c may be an example of a top plate 706, such as top plate 602 described above in reference to FIG. 6. Similarly, view 700d may be an example of a mounting plate 708, such as mounting plate 604 described above in reference to FIG. 6. It should be appreciated that the size, shape, and/or number of different layers of the heatsink 700 are only given by way of example, and that various other designs and structures are contemplated herein.

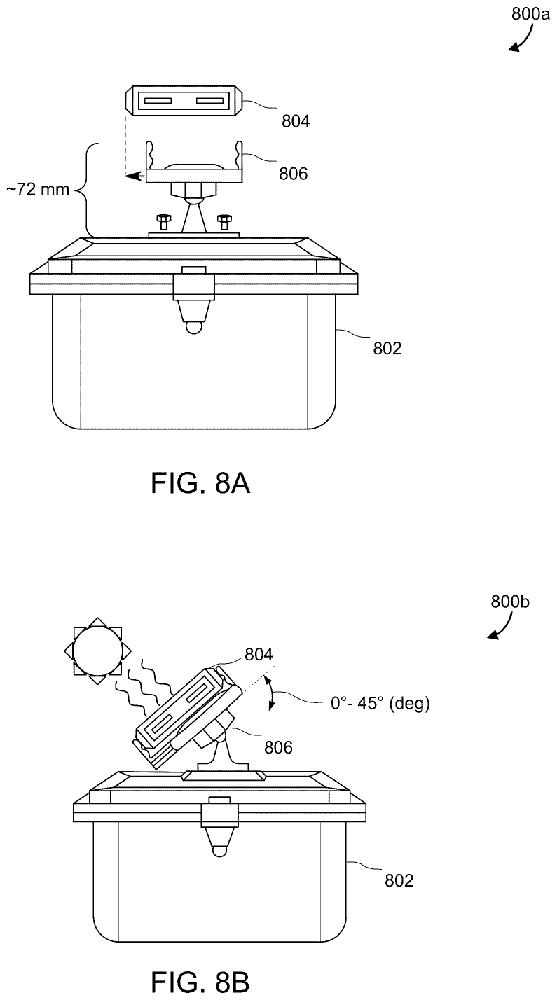

In some aspects, it may be useful to enable the mobile teaching device or system to be usable without traditional electricity. In response to this need, a mount for the case has been developed which allows a solar collecting/storage device or battery to attach to the case generating power in the field, an example of which is illustrated in FIGS. 8A-8B. As illustrated in FIGS. 8A-8B, the mobile teaching system 802 may include solar collecting/storage device or battery 804. In this implementation, the internal batteries or power storage may be removed from inside the housing of the mobile teaching device 802, such that the mobile teaching device 802 may operate solely off of an external power source. In yet some cases, various power sources and/or connectors may be provided in a single device, such as one or more of an internal power storage (e.g., capacitors/batteries of varying capacities), which may be charged by a solar collecting device, a power plug to hook into utility provided power, etc. In one specific example, the solar device 804 may include a Foxfire Torch solar power bank, attached to a Minipro Amps device mount or other similar movable mounting device 806, that may enable the solar device to rotate to face the sun to optimize or increase solar power collection, such as by 25, 30, 45, etc. degrees. In some aspects, the mounting device 806 may position the solar device above the lid of the housing of the teaching device 802 to enable the solar device 804 to rotate sufficiently without being obstructed by the housing (e.g., in one example, the height may be anywhere from 25, 50, 75 mm to a few cms, depending on the size of the teaching device and/or the solar device 804).

In some aspects, in order to connect the mobile teaching device to the projector, custom software has been developed to allow the projector to be used as the main display, such as to provide a user interface for configuring the mobile teaching system, 802. As illustrated in FIG. 8B, the solar collecting device may be mounted on a rotating mounting to the top of the housing/lid.

FIGS. 9A-9B illustrate two views 900a and 900b of an example of a mobile teaching device or system including a projection device 902 contained within a sealable housing or container 904. Not all components may be described in each example of a mobile teaching device, however, it should be appreciated that various features of the different examples may be combined in any of a variety of different combinations to provide various benefits, as described herein.

In the example of FIGS. 9A and 9B, projection device 902 may be attached to the underside of plate 906, such that an optical lens 908 of the projection device 902 aligned with a transparent window 910 formed in a side wall of the housing or container 904 when the plate 906 (also functioning as a lid in this example to housing 906) is in the closed position, such as illustrated in view 900b. In this way, in this example, the mobile teaching device may operate in a sealed state, such as to reduce damage to the device, etc. In some examples, a user interface 914, such as may include one or more aspects of user interfaces described above, may be disposed within and forming part of the housing 904, such as to, when the plate/lid is closed shut, form a sealed unit such that, in some cases, water or air cannot permeate into the interior of the housing 904. As also illustrated in the example of FIGS. 9A and 9B, a computing device/heatsink 912 may at least partially be disposed on the outside of lid/plate 906 to help reduce unwanted increase in temperature inside the mobile teaching device when operating. In some examples computing device/heatsink 912 may include one or more aspects of heatsink 600 and or 700 described above.

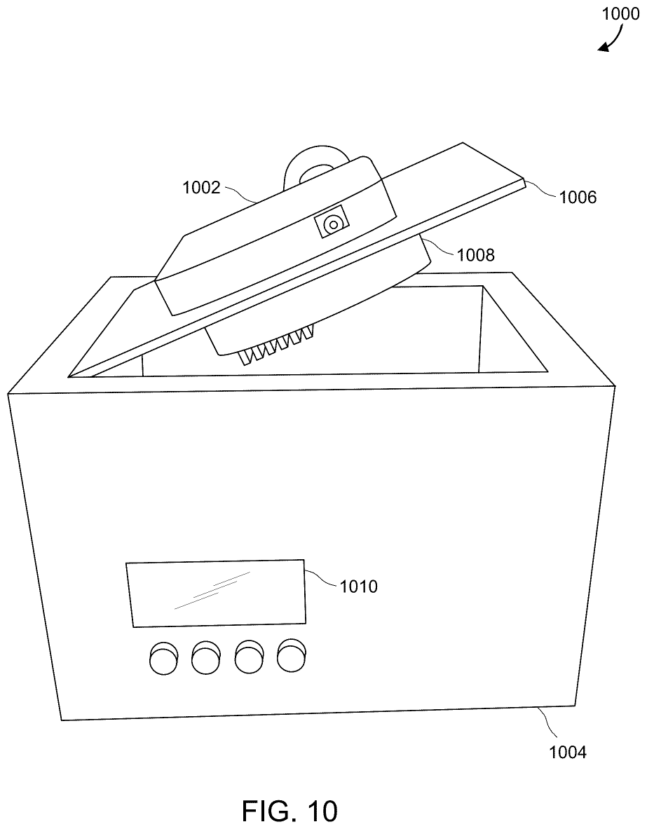

FIG. 10 illustrates an additional example of a mobile teaching device or system 1000 including a projection device 1002 extending at least partially outside of a sealable housing 1004. In some aspects, projection device 1002 may be attached to a hinged plate or lid 1006 that when closed in the down position, forms a sealed unit with housing 1004. In this example, the optical lens of the projection device 1002 may, when the lid 1006 is closed, may project outside of the housing 1004, such that no transparent window is needed. As also illustrated in the example of FIG. 10, a heatsink 1008 may at least partially be disposed on the inside of lid/plate 1006 to help reduce unwanted increase in temperature inside the mobile teaching device when operating. In some examples heatsink 1008 may include one or more aspects of heatsink 600 and or 700 described above. In some examples, a user interface 1010, such as may include one or more aspects of user interfaces described above, may be disposed within and forming part of the housing 1004, such as to, when the plate/lid is closed shut, form a sealed unit such that, in some cases, water or air cannot permeate into the interior of the housing 1004.

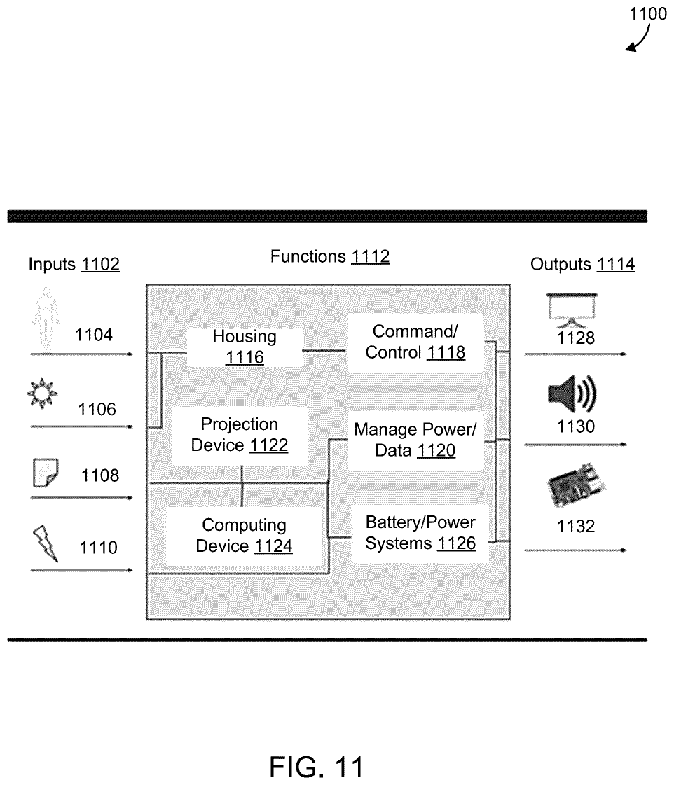

FIG. 11 illustrates a schematic of an example mobile teaching system 1100, as described in greater detail above, including inputs, functions performed by the system, and outputs, in some examples. It should be appreciated that in some cases, the system may operate without one or more inputs, without performing one or more functions, and/or without providing one or more outputs illustrated in FIG. 11, to a similar affect.

As illustrated in the mobile teaching system 1100, the various inputs 1102 to the system may include user inputs 1104, such as configuration details or parameters of and/or instructions to presenting data via the mobile teaching system 1100, selection of which sources of data to use in the presenting (e.g., selection of which digital library or offline digital library to present), selection of which power source to use, etc. Environmental inputs 1106, such as solar radiation to charge one or more power banks or batteries, such as via one or more solar collection/storage devices. Another input is data 1108, such as which digital library or libraries to present. In some cases the data may be input from a removable storage device, obtained via a wired or wireless connection to a computing device, such as a smart phone or a laptop, or via a network connection to data stored in various locations, such as data centers, content providers, etc. Another primary input is power or energy 1110, such as through a power cord, solar collection device, external batteries, and so on, which may transfer power to onboard power stress in the teaching system itself or directly power the teaching system 1100. In some cases, the teaching system 1100 may include one or more power inverters or transformers to condition power, adjust voltage and/.or current levels, frequencies etc., of the power to ensure safe and proper operation of the computing device and other components of the teaching system 1100.

The functions 1112 of the teaching system/device 1100 may include the housing all the components 1116 in a safe environment to minimize damage, etc., including the projector 1122, the computing device 1124, and the battery/power bank or power system 1126, command and control functions 1118 for configuring the device and display of data, audio and/or video outputs etc., and/or managing power and routing data 1120 to the appropriate output devices, etc. The outputs 1114 of the teaching system 1100 may include projection of text and/or graphical data, which may include video 1128, output of sound via one or more speaker or audio devices (which in some cases may link to audio inputs to enable interactive interfaces with the data 1108 and/or teaching system 1100, and/or various other outputs, such as device operational feedback, error codes, etc. 1132.

In some aspects, the mobile teaching device is designed to act as a wireless access point using various open-source linux utilities. In some examples, custom configurations of “hostapd” and “dnsmasq” make this possible. Upon boot, the device runs a custom program to manage the device. An example of the contents of this file, qrpygame.py, are as follows:

```
  import pygame
  import RPi.GPIO as GPIO
  import time
  GPIO.setwarnings(False)
  GPIO.setmode(GPIO.BCM)
  # QR Code 1, QR Code 2, Backlight On, Backlight Off
  GPIO.setup(17, GPIO.IN, pull_up_down=GPIO.PUD_UP) # DIAMOND Button for GPIO24
  GPIO.setup(23, GPIO.IN, pull_up_down=GPIO.PUD_UP) # SQUARE Button for GPIO23
  GPIO.setup(22, GPIO.IN, pull_up_down=GPIO.PUD_UP) # TRIANGLE Button for GPIO22
  GPIO.setup(5, GPIO.IN, pull_up_down=GPIO.PUD_UP) # X Button for GPIO5
  GPIO.setup(4, GPIO.IN, pull_up_down=GPIO.PUD_UP) # SIDE Button for GPIO4
  pygame.init( )
  screen = pygame.display.set_mode((500, 400), pygame.FULLSCREEN)
  pygame.mouse.set_visible(False)
  done = False
  pygame.event.set_blocked([pygame.KEYUP, pygame.MOUSEMOTION,
  pygame.MOUSEBUTTONUP,
            pygame.MOUSEBUTTONDOWN, pygame.JOYAXISMOTION,
  pygame.JOYBALLMOTION, pygame.JOYBUTTONUP,
            pygame.JOYBUTTONDOWN, pygame.JOYHATMOTION,
  pygame.VIDEORESIZE, pygame.VIDEOEXPOSE])
  # qr1 = ′/home/pi/Pictures/frame.png′
  qr1 = ′/home/pi/Pictures/frame2.png′
  qr2 = ′/home/pi/Pictures/frame3.png′
  splash = ′/home/pi/Pictures/offlineLibrarySplash.png′
  image = pygame.image.load(splash)
  image = pygame.transform.scale(image, (460, 380))
  screen.blit(image, (16, 16))
  pygame.display.update( )
  while not done:
    if GPIO.input(17) == False:
      screen.fill(0)
      image = pygame.image.load(splash)
      image = pygame.transform.scale(image, (460, 380))
      screen.blit(image, (16, 16))
      pygame.display.update( )
    if GPIO.input(23) == False:
      screen.fill(0)
      image = pygame.image.load(qr1)
      image = pygame.transform.scale(image, (380, 380))
      screen.blit(image, (16, 16))
      pygame.display.update( )
    if GPIO.input(22) == False:
      f = open(′/home/pi/screenBacklight′, ′w′)
      f.write(′1′)
      f.close( )
    if GPIO.input(5) == False:
      f = open(′/home/pi/screenBacklight′, ′w′)
      f.write(′0′)
      f.close( )
    if GPIO.input(4) == False:
  #screen.fill(0)
      image = pygame.image.load(splash)
      image = pygame.transform.scale(image, (460, 380))
      screen.blit(image, (16, 16))
      pygame.display.update( )
    time.sleep(.04)
    for event in pygame.event.get( ):
      if event.type == pygame.QUIT:
        done = True
      if event.type == pygame.KEYDOWN:
        if event.key == pygame.K_0:
          done = True
    pygame.display.flip( )
The mobile teaching device may also use a custom program named “pylogger.py” to send home
logged data.
  # importing the requests library
  import requests
  import time
  import re
  import os
  from datetime import datetime
  import shutil
  # import datefinder
  # Check for internet
  timeout = 5
  try:
    request = requests.get(″https://cashiertraining.teachbytech.org/″, timeout=timeout)
    print(″Connected to the Internet″)
  except (requests.ConnectionError, requests.Timeout) as exception:
    print(″No internet connection.″)
    exit(1)
  # api-endpoint
  URL = ″https://cashiertraining.teachbytech.org/piLog/″
  # URL = ″http://localhost:8080/piLog″
  # URL = ″http://192.168.4.75:8080/piLog″
  for x in range(10, 0, −1):
    now = datetime.now( ).strftime(′%Y%m%d%H%M%S%f′)[:−3]
    mypath = ′/home/pi/.calibre-web/calibre-web.log.′ + str(x)
    if os.path.exists(mypath):
      if os.path.getsize(mypath) != 0:
        print(os.path.exists(mypath))
        print(mypath)
        file = open(mypath)
        LOGDATA = file.read( )
        file.seek(0)
        file.close( )
        try:
          r = requests.post(url=URL, data={′logData′: LOGDATA})
          time.sleep(2)
        except (requests.ConnectionError, requests.Timeout) as exception:
          print(″POST Failed″)
          exit(1)
        shutil.copy(mypath, ″/home/pi/.calibre-web/archivedlogs/calibrelog.″ + now)
        #os.rename(mypath, ″/home/pi/.calibre-web/archivedlogs/calibrelog.″ + now)
        os.remove(mypath)
  if os.path.exists(′/home/pi/.calibre-web/calibre-web.log′):
    if os.path.getsize(′/home/pi/.calibre-web/calibre-web.log′) != 0:
      now = datetime.now( ).strftime(′%Y%m%d%H%M%S%f′)[:−3]
      mypath = ′/home/pi/.calibre-web/calibre-web.log′
      print(os.path.exists(mypath))
      print(mypath)
      file = open(mypath)
      LOGDATA = file.read( )
      file.seek(0)
      file.close( )
      try:
        r = requests.post(url=URL, data={′logData′: LOGDATA})
      except (requests.ConnectionError, requests.Timeout) as exception:
        print(″POST Failed″)
        exit(1)
      shutil.copy(mypath, ″/home/pi/.calibre-web/archivedlogs/calibrelog.″ + now)
      open(mypath, ′w′).close( )
      #os.remove(mypath)
      #os.rename(mypath, ″/home/pi/.calibre-web/archivedlogs/calibrelog.″ + now)
  # sending get request and saving the response as response object
  # r = requests.post(url=URL, data={′logData′: LOGDATA})
```

In some cases, users may use a displayed QR code to access the mobile teaching device like a wireless access point, such that the device will appear to be a wi-fi network (e.g., emulating a wi-fi router). After connecting the user is taken to a slightly modified version of “calibreweb” which uses the open-source application “calibre” to manage a vast library of books and videos which can then be downloaded and viewed on the user's smartphone, tablet, or computer. In some cases, the mobile teaching device may also have an ethernet connection, such as to download additional or new digital materials to the library.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A mobile teaching system comprising:
a sealable composite housing containing three or more of:
a computing device in communication with a memory device;
a projection device in communication with the computing device;
one or more of a removable storage device or a network device, in communication with the computing device, providing access to data comprising an offline digital library for presenting to students through the projection device; and
one or more of a heat sink in proximity to at least the computing device or a rechargeable power supply in communication with the computing device.

2. The mobile teaching system of claim 1, wherein the network device supports a wireless connection with an external computing device to access the data comprising the offline digital library.

3. The mobile teaching system of claim 1, wherein the network device comprises a device that generates a hotspot or local area network to communicate the data to one or more student computing devices.

4. The mobile teaching system of claim 1, further comprising a moveable solar collecting device in communication with the rechargeable power supply.

5. The mobile teaching system of claim 1, wherein the projection device at least in part extends outside the sealable composite housing.

6. The mobile teaching system of claim 1, wherein the computing device comprises at least one of a microprocessor or a microcomputer.

7. The mobile teaching system of claim 1, further comprising a user interface at least in part disposed on an outward facing surface of the composite container in communication with the computing device to configure display of the data through the projection device.

8. A mobile teaching device, comprising:
a display device;
a user interface;
one or more processors in communication with the protection device and the user interface; and
memory, wherein the display device, the user interface, the one or mor processors, and the memory are at least in part contained within a sealable container, the memory storing computer-executable instructions that, if executed, cause the one or more processors to:
obtain, by the mobile teaching device, data comprising a digital library for presenting to students via the display device via a removable storage device;
receive one or more instructions to configure the data for display via the user interface; and
responsive to receiving the one or more instructions, display the data through the display device.

9. The mobile teaching device of claim 8, wherein the memory stores additional computer-executable instructions that, if executed, further cause the one or more processors to:
transmit the data via a restricted network connection to one or more student computing devices.

10. The mobile teaching device of claim 8, wherein the display device comprises a projection device.

11. The mobile teaching device of claim 8, wherein the user interface comprises one or more physical buttons.

12. The mobile teaching device of claim 8, wherein the memory stores additional computer-executable instructions that, if executed, further cause the one or more processors to:
obtain additional data for presenting to the students via one or more of a wired connection or wireless network connection with a mobile computing device.

13. The mobile teaching device of claim 8, wherein the sealed container further comprises a heat sink.

14. The mobile teaching device of claim 8, further comprising one or more of a rechargeable power source or a connection device to an external power source.

15. A mobile teaching system, comprising:
a projection device;
a user interface;
one or more processors in communication with the protection device and the user interface; and
memory, wherein the projection device, the user interface, the one or more processors, and the memory are at least in part contained within a sealable container, the memory storing computer-executable instructions that, if executed, cause the one or more processors to:
obtain, by the mobile teaching system, data for presenting to students via the projection device;
receive one or more instructions to present the data via the projection device via the user interface; and
responsive to receiving the one or more instructions, present the data via the projection device.

16. The mobile teaching system of claim 15, wherein the memory stores additional computer-executable instructions that, if executed, further cause the one or more processors to:
obtain the data from a removable storage device.

17. The mobile teaching system of claim 15, wherein the memory stores additional computer-executable instructions that, if executed, further cause the one or more processors to:
obtain the data via a wireless communication link with a mobile device.

18. The mobile teaching system of claim 15, wherein the user interface comprises one or more of a touch screen or physical buttons.

19. The mobile teaching system of claim 15, wherein the sealable container comprises a waterproof housing.

20. The mobile teaching system of claim 15, wherein the memory stores additional computer-executable instructions that, if executed, further cause the one or more processors to:
transmit the data to one or more student computing devices via a restricted communication link.
